(19) United States
(12) Patent Application Publication
(10) Pub. No.: US 2025/0016800 A1
(43) Pub. Date: Jan. 9, 2025

(54) DEVICE AND METHOD FOR PROCESSING HYBRID AUTOMATIC REPEAT REQUEST (HARQ) ROUND TRIP TIME (RTT) TIMER IN SIDELINK DISCONTINUOUS RECEPTION (DRX) OPERATION IN WIRELESS COMMUNICATION SYSTEM

(71) Applicant: SAMSUNG ELECTRONICS CO., LTD., Suwon-si, Gyeonggi-do (KR)

(72) Inventors: Hyunjeong KANG, Suwon-si (KR); Anil AGIWAL, Suwon-si (KR); Kyeongin JEONG, Suwon-si (KR)

(21) Appl. No.: 18/708,575

(22) PCT Filed: Nov. 4, 2022
(86) PCT No.: PCT/KR2022/017186

§ 371 Date: May 8, 2024

Related U.S. Application Data
(60) Provisional application No. 63/276,956, filed on Nov. 8, 2021.

(51) Int. Cl. H04W 72/25; H04L 1/1829; H04W 72/0446; H04W 76/28

(52) U.S. Cl. CPC H04W 72/25; H04L 1/1864; H04W 72/0446; H04W 76/28

(57) ABSTRACT

The present disclosure relates to a 5G or 6G communication system for supporting a higher data transmission rate. The present disclosure relates to a method by which a terminal operates an HARQ RTT timer during sidelink DRX operation in a wireless communication system, the method comprising steps in which: a terminal acquires a sidelink HARQ RTT timer configuration from a transmission terminal, an NW or preconfigured information; the terminal derives a sidelink HARQ RTT timer to be applied to an HARQ process configured to be HARQ feedback enabled or to an HARQ process configured to be HARQ feedback disabled; and the terminal operates the derived sidelink HARQ RTT timer so as to perform a sidelink DRX operation.

### TECHNICAL FIELD

The disclosure relates to a wireless communication system, and more specifically, to a method and device for processing a timer related to discontinuous reception (DRX) operation of a terminal that performs sidelink-based data transmission and reception in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In addition, device-to-device communication (sidelink communication) using the 5G communication system is being studied. The device-to-device communication is expected to be applied to, for example, vehicle-to-everything (hereinafter referred to as ‘V2X’) to provide various services to users.

As various services can be provided as discussed above with the growth of a wireless communication system, a scheme of supporting a sidelink DRX procedure is required.

### DISCLOSURE OF INVENTION

### Technical Problem

The disclosure provides a method and device for processing a timer related to DRX of a terminal that performs sidelink-based data transmission/reception in a wireless communication system.

### Solution to Problem

According to an embodiment of the disclosure, a method for a terminal to process an HARQ RTT timer in sidelink DRX in a wireless communication system may include acquiring an HARQ RTT timer configuration usable when HARQ feedback is not applied; determining whether the HARQ feedback is not applied for an HARQ process; in case that the HARQ feedback is configured to be not applied for the HARQ process, determining whether a data retransmission resource is configured; and in case that the data retransmission resource is not configured, operating the HARQ RTT timer with an HARQ RTT timer configuration value usable when the HARQ feedback is not applied.

### Advantageous Effects of Invention

According to an embodiment of the disclosure, by enabling a terminal to perform a sidelink DRX operation, it is possible to minimize battery usage of the terminal consumed in unnecessary data monitoring.

### BRIEF DESCRIPTION OF DRAWINGS

FIG. 1 is a diagram illustrating a wireless communication system according to an embodiment of the disclosure.

FIG. 2 is a diagram illustrating the constitution of a base station in a wireless communication system according to an embodiment of the disclosure.

FIG. 3 is a diagram illustrating the constitution of a UE in a wireless communication system according to an embodiment of the disclosure.

FIG. 4 is a diagram illustrating the constitution of a communication unit in a wireless communication system according to an embodiment of the disclosure.

FIG. 5 is a diagram illustrating the structure of a radio time-frequency resource in a wireless communication system according to an embodiment of the disclosure.

FIG. 6A is a diagram illustrating a scenario for sidelink communication according to an embodiment of the disclosure.

FIG. 6B is a diagram illustrating a scenario for sidelink communication according to an embodiment of the disclosure.

FIG. 6C is a diagram illustrating a scenario for sidelink communication according to an embodiment of the disclosure.

FIG. 6D is a diagram illustrating a scenario for sidelink communication according to an embodiment of the disclosure.

FIG. 7A is a diagram illustrating a transmission scheme of sidelink communication according to an embodiment of the disclosure.

FIG. 7B is a diagram illustrating a transmission of sidelink communication according to an embodiment of the disclosure.

FIG. 8 is a diagram illustrating sidelink DRX configuration parameters according to an embodiment of the disclosure.

FIG. 9A is a diagram illustrating operations of processing sidelink DRX configuration information between UEs according to an embodiment of the disclosure.

FIG. 9B is a diagram illustrating operations of processing sidelink DRX configuration information between UEs according to an embodiment of the disclosure.

FIG. 10A is a diagram illustrating UE operations of processing sidelink DRX configuration information according to an embodiment of the disclosure.

FIG. 10B is a diagram illustrating UE operations of processing sidelink DRX configuration information according to an embodiment of the disclosure.

FIG. 10C is a diagram illustrating UE operations of processing sidelink DRX configuration information according to an embodiment of the disclosure.

FIG. 11A is a diagram illustrating UE operations of operating an HARQ RTT timer of sidelink DRX according to an embodiment of the disclosure.

FIG. 11B is a diagram illustrating UE operations of operating an HARQ RTT timer of sidelink DRX according to an embodiment of the disclosure.

FIG. 12 is a diagram illustrating UE operations of operating an HARQ RTT timer of sidelink DRX according to an embodiment of the disclosure.

### MODE FOR INVENTION

Hereinafter, embodiments of the disclosure will be described in detail with reference to the accompanying drawings. It should be noted that in the accompanying drawings, the same element is indicated by the same reference numeral as much as possible. In addition, detailed descriptions of well-known functions and elements that may obscure the subject matter of the disclosure will be omitted.

In describing embodiments, descriptions of technical contents that are well known in the technical field to which the disclosure pertains and are not directly related to the disclosure will be omitted. This is to more clearly convey the subject matter of the disclosure without obscuring it by omitting unnecessary description.

For the same reason, some elements are exaggerated, omitted, or schematically illustrated in the accompanying drawings. In addition, the depicted size of each element does not fully reflect the actual size. In the drawings, the same or corresponding elements are assigned the same reference numerals.

The advantages and features of the disclosure and the manner of achieving them will become apparent through embodiments described below with reference to the accompanying drawings. The disclosure may be, however, embodied in many different forms and should not be construed as being limited to the embodiments set forth herein. Rather, these embodiments are provided so that the disclosure will be thorough and complete and will fully convey the scope of the disclosure to those skilled in the art. The disclosure is only defined by the scope of the appended claims. Throughout the specification, the same reference numerals refer to the same elements.

It will be understood that each block of the flowchart illustrations, and combinations of blocks in the flowchart illustrations, may be implemented by computer program instructions. These computer program instructions may be provided to a processor of a general purpose computer, special purpose computer, or other programmable data processing apparatus to produce a machine, such that the instructions, which are executed via the processor of the computer or other programmable data processing apparatus, generate means for implementing the functions specified in the flowchart block(s). These computer program instructions may also be stored in a computer usable or computer-readable memory that may direct a computer or other programmable data processing apparatus to function in a particular manner, such that the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block(s).

In addition, each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the term ‘unit’ refers to a software element or a hardware element, such as a field programmable gate array (FPGA) or an application specific integrated circuit (ASIC), which performs a predetermined function. However, the term “unit” does not always have a meaning limited to software or hardware. A ‘unit’ may be constructed either to be stored in an addressable storage medium or to execute one or more processors. Therefore, a ‘unit’ includes, for example, software elements, object-oriented software elements, class elements or task elements, processes, functions, properties, procedures, subroutines, segments of a program code, drivers, firmware, micro-codes, circuits, data, database, data structures, tables, arrays, and variables. The functions provided by elements and ‘units’ may be combined into those of a smaller number of elements and ‘units’ or separated into those of a larger number of elements and ‘units’. In addition, the elements and ‘units’ may be implemented to operate one or more central processing units (CPUs) within a device or a secure multimedia card. Embodiments of the disclosure will be described herein focusing a wireless access network, i.e., new RAN (NR), and a packet core, i.e., a 5G system, a 5G core network, or a next generation (NG) core, according to the 5G mobile communication standard specified by the 3rd generation partnership project (3GPP) which is a mobile communication standardization organization. However, the subject matter of the disclosure can be also applied to other communication systems having similar technical backgrounds through slight modification without departing from the scope of the disclosure as will be apparent to those skilled in the art.

In the 5G system, a network data collection and analysis function (NWDAF), which is a network function of collecting, analyzing, and providing data in the 5G network, may be defined so as to support network automation. The NWDAF may collect information from the 5G network, store and analyze the collected information, and provide a result of analysis to an unspecified network function (NF). The result of analysis may be used independently in each NF.

Some terms and names defined in the 3GPP standards (e.g., 5G, NR, LTE, or similar system standards) will be used for the convenience of description. However, the disclosure is not limited by such terms and names, and may be also applied to any other system that complies with any other standard.

Hereinafter, the disclosure relates to a method and apparatus for processing sidelink DRX-related resources by a UE that performs sidelink-based data transmission/reception in a wireless communication system. The disclosure provides a method and apparatus for processing sidelink DRX resources at a UE performing data transmission and a UE performing data reception, based on sidelink unicast, sidelink groupcast, and sidelink broadcast in a wireless communication system.

Specifically, the disclosure may include the operation of a receiving UE that operates an HARQ RTT timer of sidelink DRX when sidelink HARQ feedback non-configuration is applied, and the operations of a transmitting UE and a receiving UE that process HARQ RTT timer configuration of sidelink DRX when sidelink HARQ feedback non-configuration is applied. According to an embodiment of the disclosure, by enabling a UE to perform a sidelink DRX operation, it is possible to minimize battery usage of the UE consumed in unnecessary data monitoring.

In the following description, terms referring to signals used, terms referring to channels, terms referring to control information, terms referring to network entities, terms referring to components of a device, etc. are illustratively used for convenience of description. Therefore, the disclosure is not limited by the terms as used below, and other terms referring to subjects having equivalent technical meanings may be used. Hereinafter, a base station is a subject that performs resource allocation of a terminal, and may be at least one of a gNode B (gNB), an eNode B (eNB), a Node B, a base station (BS), a radio access unit, a base station controller, or a node on a network. A terminal may include a user equipment (UE), a mobile station (MS), a cellular phone, a smart phone, a computer, or a multimedia system capable of performing a communication function. However, this is only exemplary, and the base station and the terminal are not limited to this example. In the disclosure, an eNB may be used interchangeably with a gNB for convenience of description. That is, a base station described as an eNB may indicate a gNB. In the disclosure, the term terminal may indicate various wireless communication devices as well as a mobile phone, NB-IoT devices, and sensors.

In the following description, a physical channel and a signal may be used interchangeably with data or a control signal. For example, although a physical downlink shared channel (PDSCH) is a term referring to a physical channel through which data is transmitted, the PDSCH may also be used for referring to data. That is, in the disclosure, the expression ‘transmitting a physical channel’ may be interpreted as equivalent to the expression ‘transmitting data or signals through a physical channel’.

Hereinafter, in the disclosure, higher signaling refers to a method of transmitting a signal from a base station to a UE using a downlink data channel of a physical layer or from a UE to a base station using an uplink data channel of a physical layer. The higher signaling may be understood as radio resource control (RRC) signaling or a media access control (MAC) control element (CE).

Further, in the disclosure, in order to determine whether a specific condition is satisfied or fulfilled, an expression of more than or less than is used, but this is only a description for expressing an example and does not exclude a description of a specific number or more or a specific number or less. A condition described as a ‘specific number or more’ may be replaced with ‘more than a specific number’, a condition described as a ‘specific number or less’ may be replaced with ‘less than a specific number’, and a condition described as a ‘specific number or more and less than a specific number’ may be replaced with ‘more than a specific number and a specific number or less’.

Further, although the disclosure describes embodiments using terms used in some communication standards (e.g., 3rd generation partnership project (3GPP)), this is only an example for description. The embodiments of the disclosure may be easily modified and applied in other communication systems.

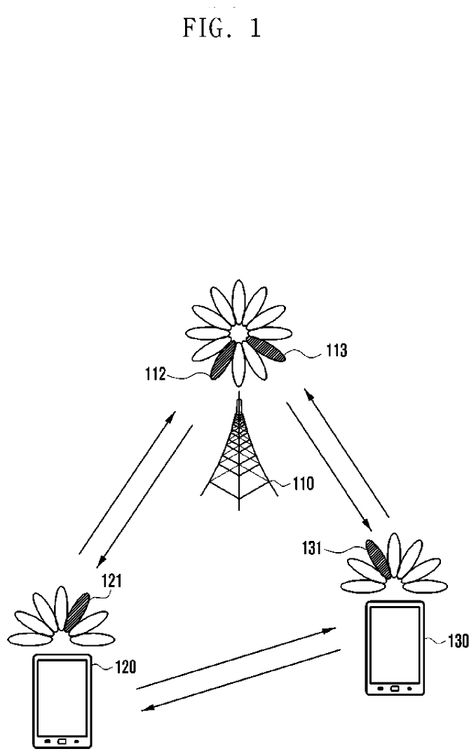

FIG. 1 is a diagram illustrating a wireless communication system according to an embodiment of the disclosure.

With reference to FIG. 1, a base station 110, a first UE 120, and a second UE 130 are exemplarily shown as some of nodes using a radio channel in a wireless communication system. Although FIG. 1 illustrates only one base station, other base stations that are identical with or similar to the base station 110 may be further included. The base station 110 is a network infrastructure that provides radio access to the UEs 120 and 130. The base station 110 has coverage defined as a predetermined geographic area based on a distance capable of transmitting a signal. In addition to the base station, the base station 110 may be referred to as an ‘access point (AP)’, ‘eNodeB (eNB)’, ‘5th generation node (5G node)’, ‘next generation nodeB (gNB)’, ‘wireless point’, ‘transmission/reception point (TRP)’, or any other term having an equivalent technical meaning.

The first UE 120 and the second UE 130 are devices used by users and can perform communication with the base station 110 through a radio channel. A link from the base station 110 to the first UE 120 or the second UE 130 is referred to as a downlink (DL), and a link from the first UE 120 or the second UE 130 to the base station 110 is referred to as an uplink (UL). Also, the first UE 120 and the second UE 130 can perform communication with each other through a radio channel. In this case, a link between the first UE 120 and the second UE 130 is referred to as a sidelink, and the sidelink may also be referred to as a PC5 interface. In some cases, at least one of the first UE 120 and the second UE 130 may be operated without the user's involvement. That is, at least one of the first UE 120 and the second UE 130 may not be carried by the user, as a device that performs machine type communication (MTC). Each of the first UE 120 and the second UE 130 may be referred to as a ‘terminal’, ‘user equipment (UE)’, ‘mobile station’, ‘subscriber station’, ‘remote terminal’, ‘wireless terminal’, ‘user device’, or any other term having an equivalent technical meaning.

The base station 110, the UE first 120, and the second UE 130 can transmit and receive radio signals in mmWave bands (e.g., 28 GHz, 30 GHz, 38 GHz, and 60 GHz). In this case, in order to improve a channel gain, the base station 110, the first UE 120, and the second UE 130 may perform beamforming. Here, beamforming may include transmission beamforming and reception beamforming. That is, the base station 110, the first UE 120, and the second UE 130 may impart directivity to a transmission signal or a reception signal. To this end, the base station 110 and the UEs 120 and 130 may select serving beams 112, 113, 121, and 131 through a beam search or beam management procedure. After the serving beams 112, 113, 121, and 131 are selected, subsequent communication may be performed through resources in a quasi-co-located (QCL) relationship with resources that has transmitted the serving beams 112, 113, 121, and 131.

If large-scale characteristics of a channel that has transmitted a symbol on a first antenna port may be inferred from a channel that has transmitted a symbol on a second antenna port, the first antenna port and the second antenna port may be evaluated to be in a QCL relationship. For example, the large-scale characteristics may include at least one of delay spread, Doppler spread, Doppler shift, average gain, average delay, or spatial receiver parameter.

The first UE 120 and the second UE 130 shown in FIG. 1 can support vehicle communication. In the case of vehicle communication, standardization work for vehicle to everything (V2X) technology was completed in 3GPP Release 14 and Release 15 based on the device-to-device (D2D) communication structure in the LTE system, and efforts are currently being made to develop V2X technology based on 5G NR. In the NR V2X, unicast communication, groupcast (or multicast) communication, and broadcast communication can be supported between UEs. In addition, unlike the LTE V2X that aims to transmit and receive basic safety information required for road driving of a vehicle, the NR V2X aims to provide more advanced services such as platooning, advanced driving, extended sensors, and remote driving.

V2X services may be divided into basic safety services and advanced services. The basic safety services may include a vehicle notification (cooperative awareness messages (CAM) or basic safety message (BSM)) service and detailed services such as a left turn notification service, a front collision warning service, an emergency vehicle approach notification service, a forward obstacle warning service, and an intersection signal information service, and V2X information may be transmitted/received using a broadcast, unicast, or groupcast transmission scheme. The advanced services not only have stronger quality of service (QOS) requirements than the basic safety services, but also require a scheme of transmitting/receiving V2X information by using unicast and groupcast transmission schemes in addition to broadcast such that V2X information can be transmitted/received within a specific vehicle group or between two vehicles. The advanced services may include detailed services such as a platooning service, an autonomous driving service, a remote driving service, and an extended sensor-based V2X service.

Hereinafter, a sidelink (SL) refers to a transmission/reception path for a signal between UEs and may be used interchangeably with a PC5 interface. Hereinafter, a base station, as a subject that performs resource allocation of a UE, may be a base station supporting both V2X communication and general cellular communication, or a base station supporting only V2X communication. That is, the base station may refer to an NR base station (e.g., gNB), an LTE base station (e.g., eNB), or a road site unit (RSU). Generally including a user equipment (UE) or a mobile station, a terminal may include a vehicle that supports vehicle-to-vehicle (V2V) communication, a vehicle or a pedestrian's handset (e.g., a smartphone) that supports vehicle-to-pedestrian (V2P) communication, a vehicle that supports vehicle-to-network (V2N) communication, a vehicle that supports vehicle-to-infrastructure (V2I) communication, an RSU having a UE function, an RSU having a base station function, or an RSU having a part of the base station function and a part of the UE function. In addition, a V2X UE used in the description below may be referred to as a UE. That is, in relation to V2X communication, a UE may be used as a V2X UE.

The base station and the UE may be connected through a Uu interface. An uplink (UL) refers to a radio link through which the UE transmits data or control signals to the base station, and a downlink (DL) refers to a radio link through which the base station transmits data or control signals to the UE.

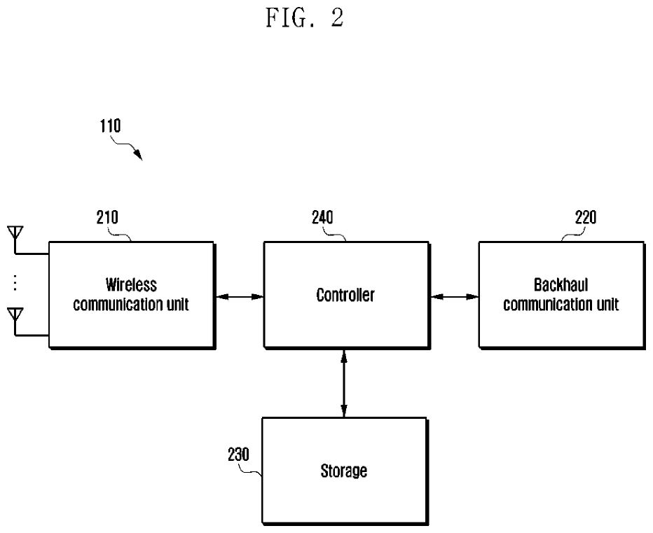

FIG. 2 is a diagram illustrating the constitution of a base station in a wireless communication system according to an embodiment of the disclosure. The constitution shown in FIG. 2 may be understood as the constitution of the base station 110. Terms such as ‘ . . . unit’, ‘ . . . er’, etc. used hereinafter refer to a unit that processes at least one function or operation, and this may be implemented with hardware, software, or a combination of hardware and software.

With reference to FIG. 2, the base station 110 may include a wireless communication unit 210, a backhaul communication unit 220, a storage 230, and a controller 240. However, elements of the base station 110 are not limited to the above example. For example, the base station may include more or fewer elements than those described above. In addition, the wireless communication unit 210, the backhaul communication unit 220, the storage 230, and the controller 240 may be implemented in the form of a single chip. Also, the controller 240 may include one or more processors.

The wireless communication unit 210 may perform functions for transmitting and receiving signals through a radio channel. For example, the wireless communication unit 210 may perform a function of conversion between a baseband signal and a bit string in accordance with a physical layer standard of a system. For example, upon transmitting data, the wireless communication unit 210 may encode and modulate a transmission bit string and thereby generate complex symbols. Also, upon receiving data, the wireless communication unit 210 may restore a reception bit string through demodulation and decoding of a baseband signal.

In addition, the wireless communication unit 210 up-converts a baseband signal into a radio frequency (RF) band signal, transmits the RF band signal through an antenna, and down-converts an RF band signal received through the antenna into a baseband signal. To this end, the wireless communication unit 210 may include a transmission filter, a reception filter, an amplifier, a mixer, an oscillator, a digital to analog converter (DAC), an analog to digital converter (ADC), and the like. Further, the wireless communication unit 210 may include a plurality of transmission and reception paths. Also, the wireless communication unit 210 may include at least one antenna array composed of a plurality of antenna elements.

In terms of hardware, the wireless communication unit 210 may be composed of a digital unit and an analog unit, and the analog unit may be composed of a plurality of sub-units according to operating power, operating frequency, and the like. The digital unit may be implemented with at least one processor (e.g., digital signal processor (DSP)).

The wireless communication unit 210 transmits and receives signals as described above. Accordingly, all or part of the wireless communication unit 210 may be referred to as a ‘transmitter’, ‘receiver’, or ‘transceiver’. Further, in the following description, transmission and reception performed through a radio channel are used in the meaning including the processing being performed as described above by the wireless communication unit 210.

The backhaul communication unit 220 may provide an interface for performing communication with other nodes in the network. That is, the backhaul communication unit 220 may convert a bit string transmitted from the base station 110 to another node, for example, another access node, another base station, an upper node, the core network, and the like into a physical signal, and convert a physical signal received from any other node to a bit string.

The storage 230 may store a default program for the operation of the base station 110, an application program, and data such as configuration information. The storage 230 may be composed of a volatile memory, a non-volatile memory, or a combination thereof. Further, the storage 230 may provide the stored data in response to the request of the controller 240.

The controller 240 may control the overall operations of the base station 110. For example, the controller 240 may transmit and receive a signal through the wireless communication unit 210 or the backhaul communication unit 220. In addition, the controller 240 writes and reads data in the storage 230. Further, the controller 240 may perform functions of a protocol stack required in the communication standard. According to another implementation example, the protocol stack may be included in the wireless communication unit 210. To this end, the controller 240 may include at least one processor. According to embodiments, the controller 240 may control the base station 110 to perform operations according to various embodiments to be described later.

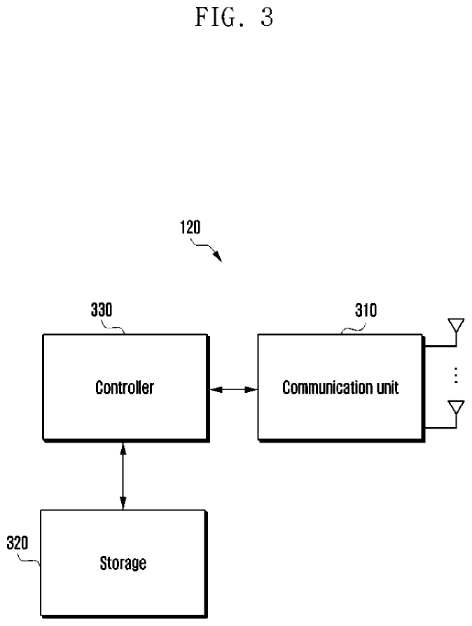

FIG. 3 is a diagram illustrating the constitution of a UE 120 or 130 (hereinafter, indicated by 120) in a wireless communication system according to an embodiment of the disclosure.

The constitution shown in FIG. 3 may be understood as the constitution of the UE 120. Terms such as ‘ . . . unit’, ‘ . . . er’, etc. used hereinafter refer to a unit that processes at least one function or operation, and this may be implemented into hardware or software, or a combination of hardware and software.

With reference to FIG. 3, the UE 120 may include a communication unit 310, a storage 320, and a controller 330. However, elements of the UE 120 are not limited to the above example. For example, the UE 120 may include more or fewer elements than those described above. In addition, the communication unit 310, the storage 320, and the controller 330 may be implemented in the form of a single chip. Also, the controller 330 may include one or more processors.

The communication unit 310 performs functions for transmitting and receiving signals through a radio channel. For example, the communication unit 310 may perform a function of conversion between a baseband signal and a bit string in accordance with a physical layer standard of a system. For example, when transmitting data, the communication unit 310 encodes and modulates a transmission bit string and thereby generates complex symbols. Also, when receiving data, the communication unit 310 restores a reception bit string through demodulation and decoding of a baseband signal. Further, the communication unit 310 up-converts a baseband signal into an RF band signal, transmits the RF band signal through an antenna, and down-converts an RF band signal received through the antenna into a baseband signal. For example, the communication unit 310 may include a transmission filter, a reception filter, an amplifier, a mixer, an oscillator, a DAC, an ADC, and the like.

Further, the communication unit 310 may include a plurality of transmission and reception paths. Also, the communication unit 310 may include at least one antenna array composed of a plurality of antenna elements. In terms of hardware, the communication unit 310 may be composed of a digital circuit and an analog circuit (e.g., radio frequency integrated circuit (RFIC)). Here, the digital circuit and the analog circuit may be implemented into one package. In addition, the communication unit 310 may include a plurality of RF chains. Also, the communication unit 310 may perform beamforming.

The communication unit 310 may transmit and receive signals as described above. Accordingly, all or part of the communication unit 310 may be referred to as a ‘transmitter’, ‘receiver’, or ‘transceiver’. Further, in the following description, transmission and reception performed through a radio channel are used in the meaning including the processing being performed as described above by the communication unit 310.

The storage 320 may store a default program for the operation of the UE 120, an application program, and data such as configuration information. The storage 320 may be composed of a volatile memory, a non-volatile memory, or a combination thereof. Further, the storage 320 provides the stored data in response to the request of the controller 330.

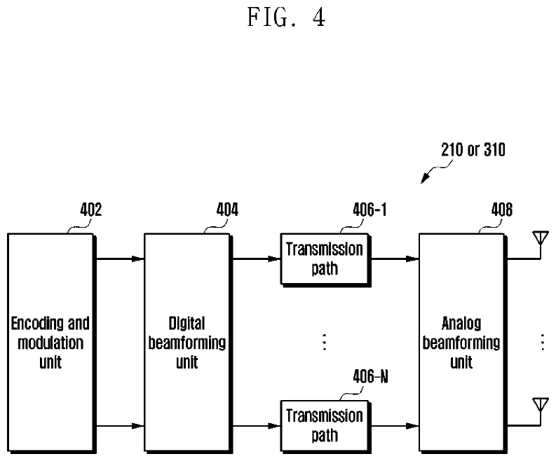

The controller 330 controls the overall operations of the UE 120. For example, the controller 330 may transmit and receive a signal through the communication unit 310. In addition, the controller 330 writes and reads data in the storage 320. Further, the controller 330 may perform functions of a protocol stack required in the communication standard. To this end, the controller 330 may include at least one processor or microprocessor or may be a part of the processor. Further, a part of the communication unit 310 and the controller 330 may be referred to as a communication processor (CP). According to embodiments, the controller 330 may control the UE 120 to perform operations according to various embodiments to be described later. FIG. 4 is a diagram illustrating the constitution of a communication unit in a wireless communication system according to an embodiment of the disclosure.

FIG. 4 illustrates an example of a detailed constitution of the wireless communication unit 210 of FIG. 2 or the communication unit 310 of FIG. 3. Specifically, FIG. 4 illustrates elements for performing beamforming as a part of the wireless communication unit 210 of FIG. 2 or the communication unit 310 of FIG. 3.

With reference to FIG. 4, the wireless communication unit 210 or the communication unit 310 may include an encoding and modulation unit 402, a digital beamforming unit 404, a plurality of transmission paths 406-1 to 406-N, and an analog beamforming unit 408.

The encoding and modulation unit 402 may perform channel encoding. For channel encoding, at least one of a low density parity identify (LDPC) code, a convolution code, and a polar code may be used. The encoding and modulation unit 402 may perform constellation mapping and thereby generate modulation symbols.

The digital beamforming unit 404 may perform beamforming on a digital signal (e.g., modulation symbols). To this end, the digital beamforming unit 404 multiplies modulation symbols by beamforming weights. Here, the beamforming weights are used for changing the magnitude and phase of a signal, and may be referred to as a ‘precoding matrix’, a ‘precoder’, or the like. The digital beamforming unit 404 may output digital-beamformed modulation symbols to a plurality of transmission paths 406-1 to 406-N. In this case, depending on a multiple input multiple output (MIMO) transmission technique, modulation symbols may be multiplexed or the same modulation symbols may be provided to the plurality of transmission paths 406-1 to 406-N.

The plurality of transmission paths 406-1 to 406-N may convert digital-beamformed digital signals into analog signals. To this end, each of the plurality of transmission paths 406-1 to 406-N may include an inverse fast Fourier transform (IFFT) operation unit, a cyclic prefix (CP) insertion unit, a DAC, and an up-conversion unit. The CP insertion unit is for an orthogonal frequency division multiplexing (OFDM) scheme and may be excluded in the case that any other physical layer scheme (e.g., filter bank multi-carrier (FBMC)) is applied. That is, the plurality of transmission paths 406-1 to 406-N may provide independent signal processing processes for a plurality of streams generated through digital beamforming. However, depending on implementation types, some of elements of the plurality of transmission paths 406-1 to 406-N may be used in common.

The analog beamforming unit 408 may perform beamforming on an analog signal. To this end, the digital beamforming unit 404 may multiply the analog signals by beamforming weights. Here, the beamforming weights are used for changing the magnitude and phase of the signal. Specifically, the analog beamforming unit 408 may be variously configured depending on a connection structure between the plurality of transmission paths 406-1 to 406-N and antennas. For example, each of the plurality of transmission paths 406-1 to 406-N may be connected to one antenna array. In another example, the plurality of transmission paths 406-1 to 406-N may be connected to one antenna array. In still another example, the plurality of transmission paths 406-1 to 406-N may be adaptively connected to one antenna array or connected to two or more antenna arrays.

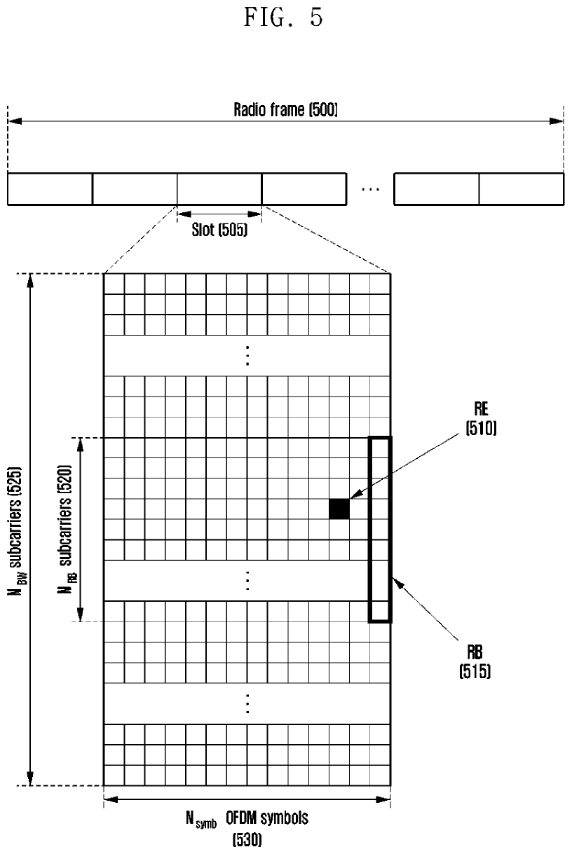

FIG. 5 is a diagram illustrating the structure of a radio time-frequency resource in a wireless communication system according to an embodiment of the disclosure. With reference to FIG. 5, the horizontal axis represents the time domain and the vertical axis represents the frequency domain in the radio resource domain. The minimum transmission unit in the time domain is an OFDM symbol or a DFT-S-OFDM symbol, and N_{symb} OFDM symbols or DFT-S-OFDM symbols 530 may be contained in one slot 505. Unlike the slot, in the NR system, the length of a subframe may be defined as 1.0 ms, and the length of a radio frame 500 may be defined as 10 ms. The minimum transmission unit in the frequency domain is a subcarrier, and the entire system transmission bandwidth may include a total of N_{BW} subcarriers 525. Specific values such as N_{symb} and N_{BW} may be applied variably depending on the system.

A basic unit of the time-frequency resource domain is a resource element (RE) 510, which may be represented by an OFDM symbol index or a DFT-S-OFDM symbol index and a subcarrier index. A resource block (RB) 515 may be defined as N_{RB} consecutive subcarriers 520 in the frequency domain. In general, the minimum transmission unit of data is an RB unit, and in the NR system, N_{symb} is 14 and N_{RB} is 12.

The radio time-frequency resource structure as shown in FIG. 5 is applied to the Uu interface. In addition, the radio time-frequency resource allocation as shown in FIG. 5 may be similarly applied to the sidelink.

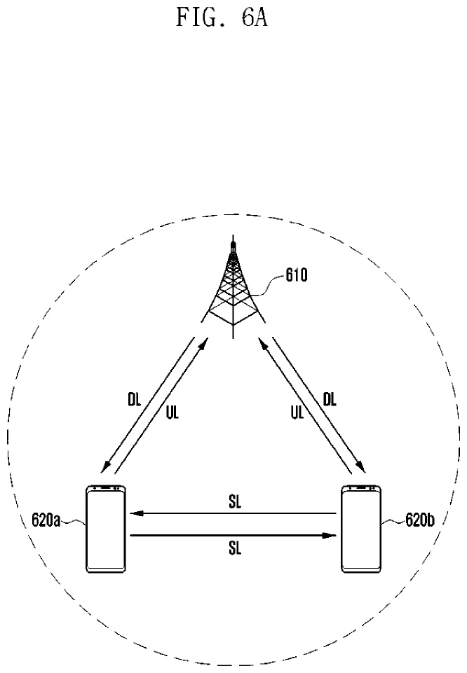

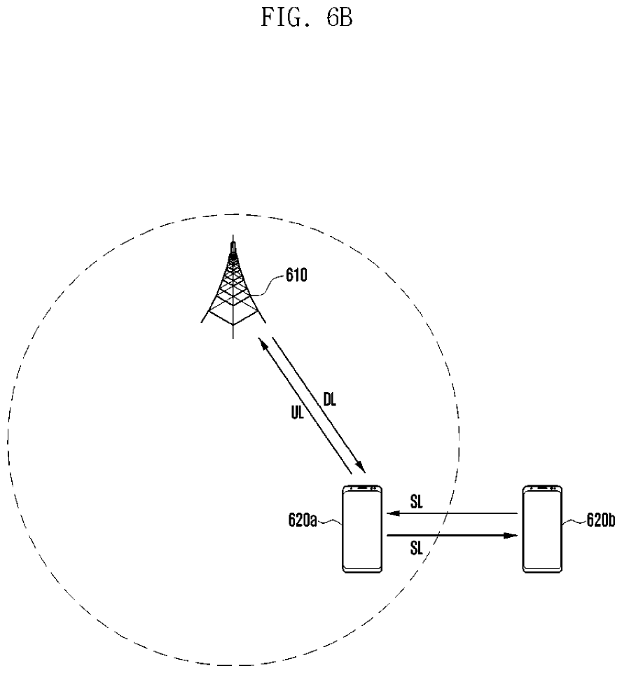

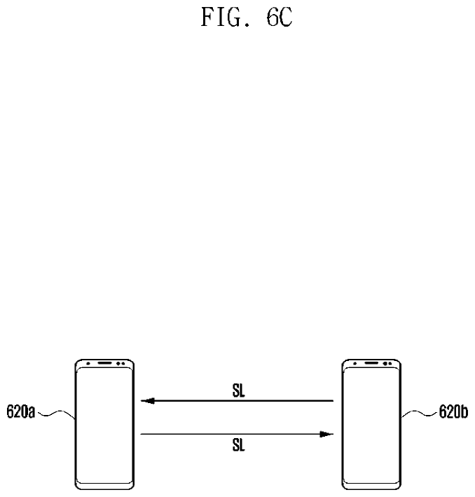

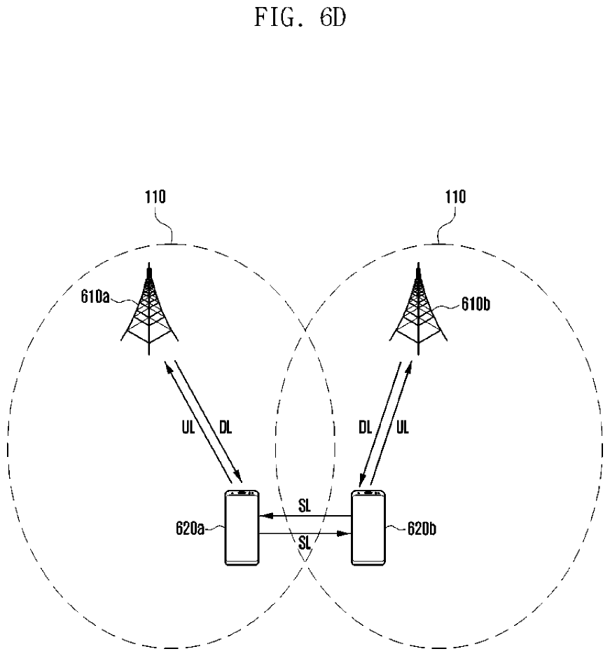

FIG. 6A is a diagram illustrating a scenario for sidelink communication according to an embodiment of the disclosure.

FIG. 6A exemplarily shows an in-coverage scenario in which sidelink UEs 620a and 620b are located within the coverage of a base station 610. The sidelink UEs 620a and 620b are capable of receiving data and control information from the base station 610 through a downlink (DL) or transmitting data and control information to the base station 610 through an uplink (UL). These data and control information may be those for sidelink communication or those for general cellular communication other than the sidelink communication. In addition, the sidelink UEs 620a and 620b are capable of transmitting/receiving data and control information for sidelink communication through a sidelink.

FIG. 6B is a diagram illustrating a scenario for sidelink communication according to an embodiment of the disclosure.

FIG. 6B exemplarily shows a partial coverage scenario in which, among sidelink UEs, a first UE 620a is located within the coverage of the base station 610 and a second UE 620b is located outside the coverage of the base station 610. The first UE 620a located within the coverage of the base station 610 is capable of receiving data and control information from the base station 610 through the downlink or transmitting data and control information to the base station 610 through the uplink. The second UE 620b located out of the coverage of the base station 610 is incapable of receiving data and control information from the base station 610 through the downlink and incapable of transmitting data and control information to the base station 610 through the uplink.

The second UE 620b is capable of transmitting/receiving data and control information for sidelink communication to/from the first UE 620a through the sidelink. FIG. 6C is a diagram illustrating a scenario for sidelink communication according to an embodiment of the disclosure.

FIG. 6C shows an out-of-coverage scenario in which sidelink UEs (e.g., a first UE 620a and a second UE 620b) are located out of the coverage of the base station. Therefore, the first UE 620a and the second UE 620b are incapable of receiving data and control information from the base station through the downlink and incapable of transmitting data and control information to the base station through the uplink. The first UE 620a and the second UE 620b are capable of transmitting/receiving data and control information for sidelink communication through the sidelink.

FIG. 6D is a diagram illustrating a scenario for sidelink communication according to an embodiment of the disclosure.

With reference to FIG. 6D, a first UE 620a and a second UE 620b performing sidelink communication may perform inter-cell sidelink communication in an access state (e.g., RRC connected state) or camping state (e.g., RRC connection release state, i.e., an RRC idle state) with different base stations (e.g., a first base station 610a and a second base station 610b). In this case, the first UE 620a may be a sidelink transmitting UE, and the second UE 620b may be a sidelink receiving UE. Alternatively, the first UE 620a may be a sidelink receiving UE, and the second UE 620b may be a sidelink transmitting UE. The first UE 620a may receive a system information block (SIB) dedicated to sidelink from a base station 610a which the first UE 620a is connected to (or is camping on), and the second UE 620b may receive the SIB dedicated to sidelink from another base station 610b which the second UE 620b is connected to (is camping on). In this case, information of the sidelink-dedicated SIB received by the first UE 620a and information of the sidelink-dedicated SIB received by the second UE 620b may be different from each other. Therefore, to enable sidelink communication between UEs located in different cells, information needs to be unified.

Although FIGS. 6A to 6D illustrate a sidelink system composed of two UEs (e.g., the first UE 620a and the second UE 620b) for convenience of description, the disclosure is not limited to the above example and this may also be applied to a sidelink system in which more than two UEs participate. In addition, the uplink and downlink between the base station 610, 610a, or 610b and the sidelink UE 620a or 620b may be referred to as a Uu interface, and the sidelink between the sidelink UEs may be referred to as a PC-5 interface. In the following description, the uplink or downlink and the Uu interface may be used interchangeably, and the sidelink and the PC-5 interface may be used interchangeably.

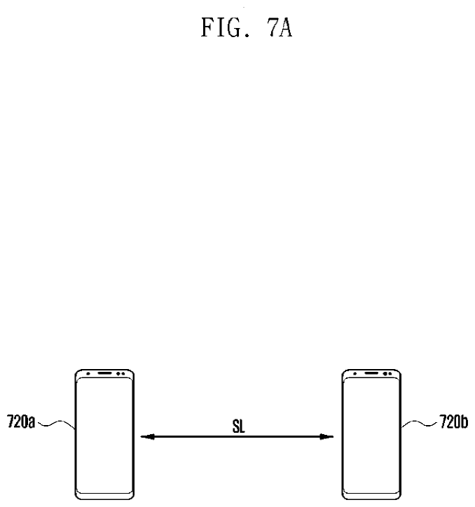

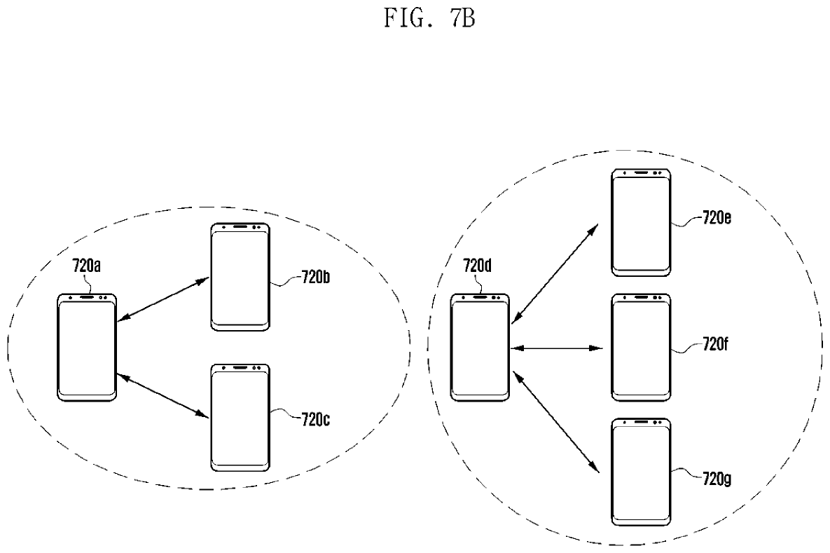

Meanwhile, in the disclosure, the UE may refer to a vehicle that supports vehicle-to-vehicle (V2V) communication, a vehicle or a pedestrian's handset (e.g., a smartphone) that supports vehicle-to-pedestrian (V2P) communication, a vehicle that supports vehicle-to-network (V2N) communication, or a vehicle that supports vehicle-to-infrastructure (V2I) communication. In addition, in the disclosure, the UE may refer to a road side unit (RSU) having a UE function, an RSU having a base station function, or an RSU having a part of the base station function and a part of the UE function. FIGS. 7A and 7B are diagrams illustrating a transmission scheme of sidelink communication according to an embodiment of the disclosure.

Specifically, FIG. 7A shows a unicast scheme, and FIG. 7B shows a groupcast scheme. With reference to FIG. 7A, a transmitting UE 720a and a receiving UE 720b may perform one-to-one communication. The transmission scheme of FIG. 7A may be referred to as unicast communication. With reference to FIG. 7B, a transmitting UE 720a or 720d and receiving UEs 720b, 720c, 720e, 702f, and 720g may perform one-to-many communication. The transmission scheme of FIG. 7B may be referred to as groupcast or multicast communication. In FIG. 7B, a first UE 720a, a second UE 720b, and a third UE 720c may form one group (group A) and perform groupcast communication, and a fourth UE 720d, a fifth UE 720e, a sixth UE 720f, and a seventh UE 720g may form another group (group B) and perform groupcast communication. Each UE may perform groupcast communication within a group to which it belongs, and may perform unicast, groupcast, or broadcast communication with at least one UE belonging to any other group. Although two groups are illustrated in FIG. 7B for convenience of description, the disclosure is not limited to this and may also be applied to even the case where a larger number of groups are formed.

On the other hand, although not shown in FIGS. 7A and 7B, sidelink UEs may perform broadcast communication. The broadcast communication refers to a scheme in which all sidelink UEs receive data and control information transmitted by a sidelink transmitting UE through a sidelink. For example, if the first UE 720a is a transmitting UE in FIG. 7B, the remaining UEs 720b, 720c, 720d, 720e, 720f, and 720g may receive data and control information transmitted by the first UE 720a.

The above-described sidelink unicast communication, groupcast communication, and broadcast communication may be supported in the in-coverage scenario, partial-coverage scenario, or out-of-coverage scenario.

In the case of the NR sidelink, unlike the LTE sidelink, it may be considered to support a transmission form in which a vehicle UE transmits data to only one specific UE through unicast, and a transmission form in which a vehicle UE transmits data to a plurality of specific UEs through groupcast. For example, in the case of considering a service scenario such as platooning, which is a technology in which two or more vehicles are connected into one network and moved in a cluster form, these unicast and groupcast technologies can be usefully used. Specifically, a leader UE of a group connected by platooning can use unicast communication for the purpose of controlling one specific UE and use groupcast communication for the purpose of simultaneously controlling a group composed of a plurality of specific UEs.

In the V2X system, the following methods may be used for resource allocation.

### (1) Mode 1 Resource Allocation

Scheduled resource allocation is a method in which the base station allocates resources used for sidelink transmission to RRC-connected UEs in a dedicated scheduling scheme. The scheduled resource allocation method may be effective for interference management and resource pool management (dynamic allocation and/or semi-persistent transmission) because the base station can manage sidelink resources. In the case where there is data to be transmitted to other UE(s), the UE in the RRC connection mode may transmit, to the base station by using an RRC message or a MAC control element (CE), information notifying that there is data to be transmitted to other UE(s).

For example, the RRC message transmitted by the UE to the base station may be a sidelink UE information message, a UE assistance information message, etc., and the MAC CE may correspond to a BSR MAC CE including at least one of an indicator indicating a buffer status report (BSR) for V2X communication and information on the size of buffered data for sidelink communication, a scheduling request (SR), or the like.

### (2) Mode 2 Resource Allocation

Second, UE autonomous resource selection is a method in which a sidelink transmission and reception resource pool for V2X is provided to the UE via system information or RRC messages (e.g., an RRC reconfiguration message, a PC5-RRC message) and the UE selects a resource pool and resources in accordance with a predetermined rule. The UE autonomous resource selection may correspond to one or more of the following resource allocation methods.
The UE autonomously selects sidelink resource for transmission.
The UE assists sidelink resource selection for other UEs.
The UE is configured with NR configured grant for sidelink transmission.
The UE schedules sidelink transmission of other UEs.
Resource selection methods of the UE may include zone mapping, sensing-based resource selection, random selection, and the like.
In addition, even if the UE exists in the coverage of the base station, resource allocation or resource selection may not be performed in the scheduled resource allocation or UE autonomous resource selection mode. In this case, the UE may perform V2X sidelink communication in a UE random selection scheme through a preconfigured exceptional sidelink transmission and reception resource pool.
Also, in the case that UEs for V2X communication exist outside the coverage of the base station, the UE may perform V2X sidelink communication through a preconfigured sidelink transmission and reception resource pool.

In the case that the UE transmits and receives sidelink-based data, the sidelink-based data may be transmitted in a broadcast scheme or a groupcast scheme. In the case that the UE transmits and receives sidelink-based data in a unicast scheme, PC5-S signaling (e.g., sidelink (SL) unicast connection setup message) transmitted until a PC5 unicast connection between two UEs is established may be transmitted in a broadcast scheme. The disclosure will describe, through various embodiments, a scheme of processing sidelink DRX in the case where one UE transmits sidelink signaling to one or more UEs in a broadcast scheme, a groupcast scheme, or a unicast scheme.

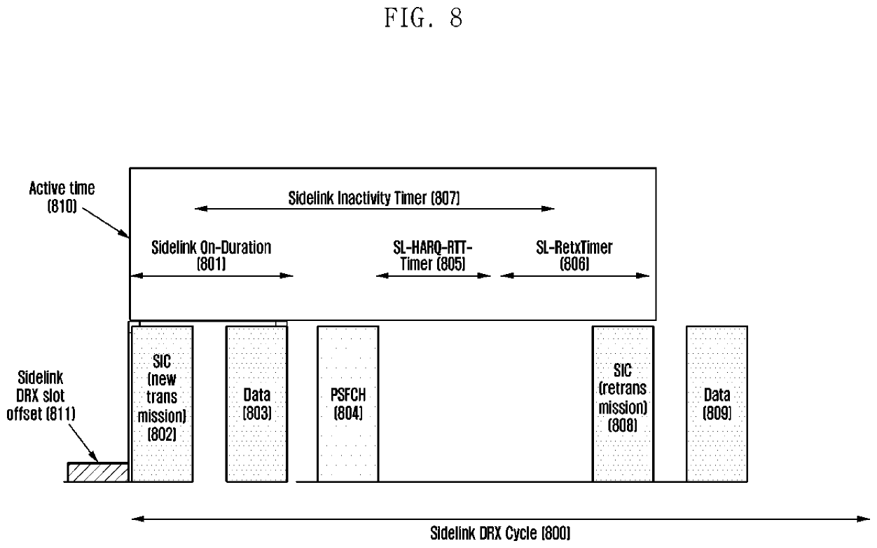

FIG. 8 is a diagram illustrating sidelink DRX configuration parameters according to an embodiment of the disclosure.

With reference to FIG. 8, a sidelink DRX cycle 800 may be composed of an on-duration 801 and a DRX opportunity (not shown). In the case that sidelink DRX is configured, a receiving UE may monitor a reception resource pool in the on-duration 801. The receiving UE may not monitor the reception resource pool in the DRX opportunity 803. In the case that sidelink DRX is configured, a transmitting UE may transmit sidelink control information 802 and data 803 through transmission resources acquired from a transmission resource pool in the on-duration 801. When sidelink DRX is configured, the transmitting UE and the receiving UE may acquire sidelink DRX configuration information including at least one of information on the sidelink DRX cycle 800 and information on the on-duration 801. The transmitting UE may acquire the sidelink DRX configuration information from a network (NW) (through an RRC dedicated message or a system information message) or from preconfigured information. The NW may be at least one entity (or function) of a core network (CN) or may be a base station (RAN), and it is not limited to the above example and may include all entities other than the UE supporting sidelink communication. The receiving UE may acquire the sidelink DRX configuration information from a counterpart UE (e.g., the transmitting UE) performing sidelink unicast-based communication, from the NW, or from preconfigured information. The UEs performing the sidelink unicast-based communication may acquire the sidelink DRX configuration information including at least one of information on the sidelink DRX cycle 800 and information on the on-duration 801 through PC5-RRC connection setup signaling.

In the case that sidelink DRX is configured, sidelink DRX parameters to be processed by the transmitting UE and the receiving UE may be at least one or a combination of those listed in Table 1 below.

TABLE 1
sidelink on-duration (801): duration at the beginning of a DRX cycle
sidelink inactivity-timer (807): duration after the SCI occasion in which a
SCI indicates a new SL transmission for the MAC entity
sidelink retransmission-timer (806): maximum duration until a
retransmission is received (or maximum duration until a SL grant for
retransmission is received)
sidelink HARQ RTT-timer (805): minimum duration before a
retransmission is expected by the MAC entity
sidelink DRX cycle (800): specifies the periodic repetition of the on-
duration followed by a possible period of inactivity
sidelink DRX slot offset (811): the delay before starting the on-duration
timer (801)
active-time (810) includes the time while on-duration or inactivity-timer
or retransmission-timer is running

According to an embodiment of the disclosure, the sidelink HARQ RTT timer may be configured with the same value for an HARQ process configured to HARQ feedback enabled and an HARQ process configured to HARQ feedback disabled. According to an embodiment of the disclosure, the sidelink HARQ RTT timer may be configured with different values for the HARQ process configured to HARQ feedback enabled and the HARQ process configured to HARQ feedback disabled.

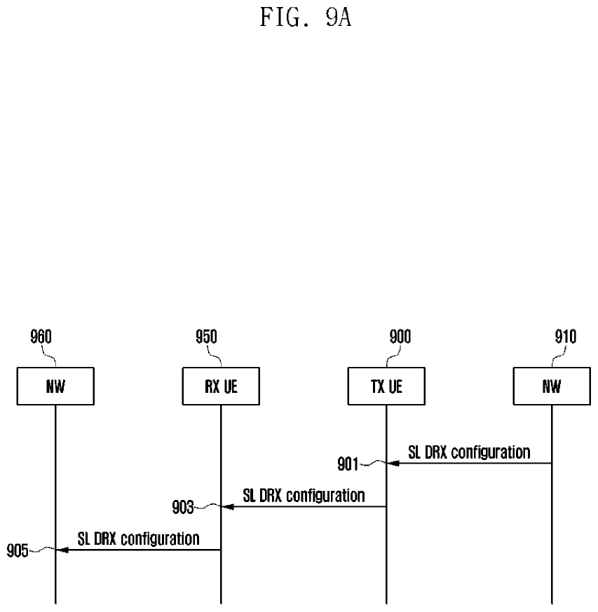

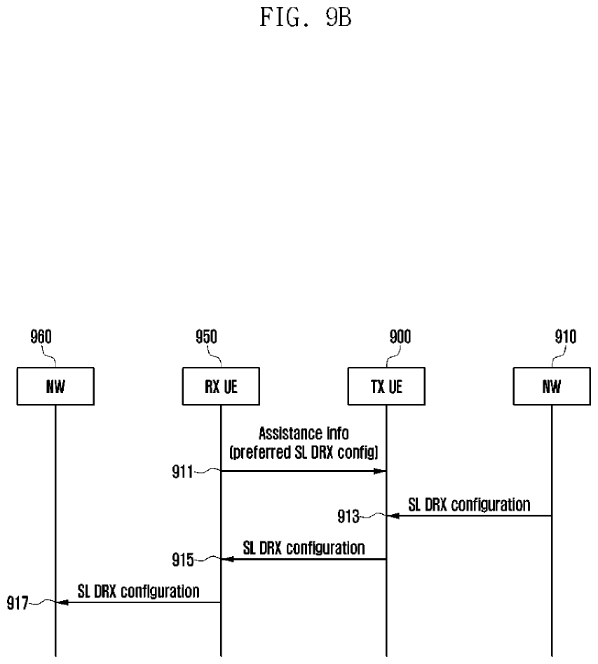

FIG. 9A is a diagram illustrating operations of processing sidelink DRX configuration information between UEs according to an embodiment of the disclosure.

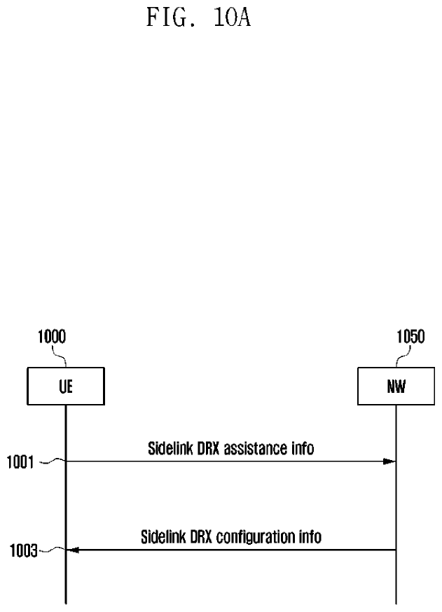

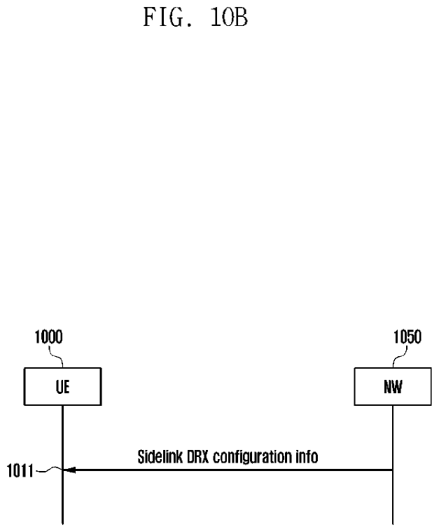

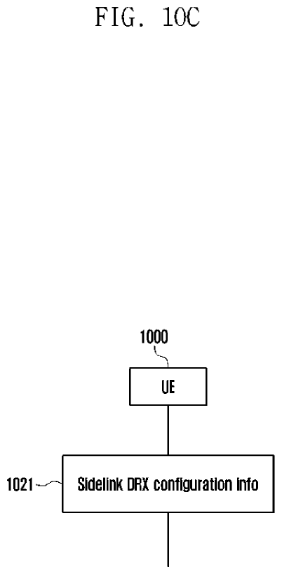

With reference to FIG. 9A, if a transmitting UE 900 is capable of supporting a sidelink DRX function, the transmitting UE 900 may acquire sidelink DRX configuration information from a NW 910 in step 901. The sidelink DRX configuration information acquired by the transmitting UE 900 in step 901 may include sidelink HARQ RTT timer configuration information. When HARQ feedback is configured for at least one or more sidelink logical channels transmitted by the transmitting UE 900 (e.g., when HARQ feedback enabled is configured), the sidelink HARQ RTT timer may be configured with a value that can be used in the corresponding HARQ process. When HARQ feedback is not configured for at least one or more sidelink logical channels transmitted by the transmitting UE 900 (e.g., when HARQ feedback disabled is configured), the sidelink HARQ RTT timer may be configured with a value that can be used in the corresponding HARQ process. In an embodiment, the sidelink HARQ RTT timer to be used when HARQ feedback is not configured may be configured with 0 or a value greater than 0. In an embodiment, if the sidelink HARQ RTT timer for the case where HARQ feedback is not configured is not included in the sidelink DRX configuration information acquired in step 901, the sidelink HARQ RTT timer to be used when HARQ feedback is not configured may be interpreted as 0. For example, a sidelink HARQ RTT timer parameter for the case where HARQ feedback is not configured may be included in the sidelink DRX configuration information acquired in step 901 only when it is configured with a value greater than 0. When the transmitting UE 900 is in the RRC_CONNECTED state, the transmitting UE 900 may transmit sidelink DRX assistance information to the NW 910 before step 901. The sidelink DRX assistance information may include sidelink DRX configuration information preferred by the transmitting UE 900. When the transmitting UE 900 is in the RRC CONNECTED state, RRC_IDLE/RRC_INACTIVE state, or OUT-OF-COVERAGE state, the operation of acquiring the sidelink DRX configuration information from the NW 900 or in a pre-configuration scheme will be described with reference to FIGS. 10A, 10B, and 10C. If the transmitting UE 900 determines that it can perform a sidelink DRX operation with a receiving UE 950 performing sidelink unicast-based communication, the transmitting UE 900 may transmit the sidelink DRX configuration information to the receiving UE 950 in step 903. The sidelink DRX configuration information may be transmitted through a unicast-based PC5 RRC message between the transmitting UE 900 and the receiving UE 950. The sidelink DRX configuration information exchanged between the transmitting UE 900 and the receiving UE 950 may include information shown in Table 1 above. In step 903, the transmitting UE 900 may transmit to the receiving UE 950 a sidelink HARQ RTT value that can be used in the HARQ process configured to HARQ feedback disabled. In an embodiment, the sidelink HARQ RTT timer to be used when HARQ feedback is not configured may be configured with 0 or a value greater than 0. In an embodiment, if the sidelink HARQ RTT timer for the case where HARQ feedback is not configured is not included in the sidelink DRX configuration information acquired in step 903, the sidelink HARQ RTT timer to be used when HARQ feedback is not configured may be interpreted as 0. For example, a sidelink HARQ RTT timer parameter for the case where HARQ feedback is not configured may be included in the sidelink DRX configuration information in step 903 only when it is configured with a value greater than 0. The transmitting UE 900 and the receiving UE 950 may perform sidelink DRX-based data and signaling transmission/reception based on the sidelink DRX configuration information. When the receiving UE 950 is in the RRC CONNECTED state, the receiving UE 950 may transmit the sidelink DRX configuration information to a connected NW 960 in step 905. This information can be referenced when performing Uu-based data and signaling transmission/reception between the NW 960 and the receiving UE 950 or when operating Uu DRX. The NW 910 and the NW 960 may be the same base station or different base stations.

FIG. 9B is a diagram illustrating operations of processing sidelink DRX configuration information between UEs according to an embodiment of the disclosure.

With reference to FIG. 9B, the transmitting UE 900 is capable of supporting the sidelink DRX function and acquiring sidelink DRX assistance information from the receiving UE 950 in step 911. The sidelink DRX assistance information acquired in step 911 may include sidelink DRX configuration information preferred by the receiving UE 950, and this information may include information shown in Table 1. The transmitting UE 900 may acquire sidelink DRX configuration information from the NW 910 in step 913. The sidelink DRX configuration information acquired by the transmitting UE 900 in step 913 may include sidelink HARQ RTT timer configuration information. When HARQ feedback is configured for at least one or more sidelink logical channels transmitted by the transmitting UE 900 (e.g., when HARQ feedback enabled is configured), the sidelink HARQ RTT timer may be configured with a value that can be used in the corresponding HARQ process. When HARQ feedback is not configured for at least one or more sidelink logical channels transmitted by the transmitting UE 900 (e.g., when HARQ feedback disabled is configured), the sidelink HARQ RTT timer may be configured with a value that can be used in the corresponding HARQ process. In an embodiment, the sidelink HARQ RTT timer to be used when HARQ feedback is not configured may be configured with 0 or a value greater than 0. In an embodiment, if the sidelink HARQ RTT timer for the case where HARQ feedback is not configured is not included in the sidelink DRX configuration information acquired in step 913, the sidelink HARQ RTT timer to be used when HARQ feedback is not configured may be interpreted as 0. For example, a sidelink HARQ RTT timer parameter for the case where HARQ feedback is not configured may be included in the sidelink DRX configuration information acquired in step 913 only when it is configured with a value greater than 0. When the transmitting UE 900 is in the RRC_CONNECTED state, the transmitting UE 900 may transmit sidelink DRX assistance information to the NW 910 before step 913. The sidelink DRX assistance information transmitted from the transmitting UE 900 to the NW 910 may include at least one of the preferred sidelink DRX configuration information of the receiving UE 950 acquired in step 911, and preferred sidelink DRX configuration information of the transmitting UE 900. When the transmitting UE 900 is in the RRC_CONNECTED state, RRC_IDLE/RRC_INACTIVE state, or OUT-OF-COVERAGE state, the operation of acquiring the sidelink DRX configuration information from the NW 900 or in a pre-configuration scheme will be described with reference to FIGS. 10A, 10B, and 10C. If the transmitting UE 900 determines that it can perform a sidelink DRX operation with the receiving UE 950 performing sidelink unicast-based communication, the transmitting UE 900 may transmit the sidelink DRX configuration information to the receiving UE 950 in step 915. The sidelink DRX configuration information exchanged between the transmitting UE 900 and the receiving UE 950 may include information shown in Table 1 above. The sidelink DRX configuration information may be transmitted through a unicast-based PC5 RRC message between the transmitting UE 900 and the receiving UE 950. In step 915, the transmitting UE 900 may transmit to the receiving UE 950 a sidelink HARQ RTT value that can be used in the HARQ process configured to HARQ feedback disabled. In an embodiment, the sidelink HARQ RTT timer to be used when HARQ feedback is not configured may be configured with 0 or a value greater than 0. In an embodiment, if the sidelink HARQ RTT timer for the case where HARQ feedback is not configured is not included in the sidelink DRX configuration information acquired in step 915, the sidelink HARQ RTT timer to be used when HARQ feedback is not configured may be interpreted as 0. That is, a sidelink HARQ RTT timer parameter for the case where HARQ feedback is not configured may be included in the sidelink DRX configuration information in step 915 only when it is configured with a value greater than 0. The transmitting UE 900 and the receiving UE 950 may perform sidelink DRX-based data and signaling transmission/reception based on the sidelink DRX configuration information. When the receiving UE 950 is in the RRC_CONNECTED state, the receiving UE 950 may transmit the sidelink DRX configuration information to the connected NW 960 in step 917. This information can be referenced when performing Uu-based data and signaling transmission/reception between the NW 960 and the receiving UE 950 or when operating Uu DRX. The NW 910 and the NW 960 may be the same base station or different base stations.

FIGS. 10A to 10C are diagrams illustrating UE operations of processing sidelink DRX configuration information according to various embodiments of the disclosure. FIG. 10A shows a case where the UE performs sidelink-based data transmission and reception in the RRC_CONNECTED state, FIG. 10B shows a case where the UE performs sidelink-based data transmission and reception in the RRC_IDLE state or RRC INACTIVE state, and FIG. 10C shows a case where the UE performs sidelink-based data transmission and reception in the OUT_OF_COVERAGE state.

With reference to FIG. 10A, a UE 1000 may transmit signaling including sidelink DRX assistance information to a NW 1050 in step 1001. The signaling including the sidelink DRX assistance information may include at least one of a UEAssistanceInformation message or a SidelinkUEInformation message. Of course, it is not limited to the above example.

The sidelink DRX assistance information may include at least one or a combination of destination ID corresponding to an interested service of the UE, destination ID corresponding to an interested group of the UE, sidelink flow, PQI of the sidelink flow, frequency corresponding to the interested service of the UE, traffic pattern information (period, message size, time offset, etc.) of the interested service of the UE, sidelink DRX configuration information preferred by the transmitting UE, and sidelink DRX configuration information preferred by the receiving UE.

The NW 1050, which has received the sidelink DRX assistance information in step 1001, may provide the sidelink DRX configuration information to the UE 1000. For example, in step 1003, the NW 1050 may transmit signaling including the sidelink DRX configuration information to the UE 1000. The sidelink DRX configuration information may include at least one or a combination of a sidelink DRX cycle, sidelink on-duration, sidelink inactivity-timer, and sidelink HARQ RTT timer to be used by the UE with sidelink DRX configured. The sidelink HARQ RTT timer may be configured with a value that can be used in the corresponding HARQ process when HARQ feedback is configured for at least one or more sidelink logical channels (e.g., when HARQ feedback enabled is configured). The sidelink HARQ RTT timer may be configured with a value that can be used in the corresponding HARQ process when HARQ feedback is not configured for at least one or more sidelink logical channels (e.g., when HARQ feedback disabled is configured).

With reference to FIG. 10B, the UE 1000 may acquire sidelink DRX configuration information from the NW 1050 in step 1011. For example, the UE 1000 may receive the sidelink DRX configuration information from the NW 1050 in step 1011. The sidelink DRX configuration information may be included in a sidelink system information message transmitted by the NW 1050. Of course, it is not limited to the above example.

The sidelink DRX configuration information may include at least one or a combination of a sidelink DRX cycle, sidelink on-duration, sidelink inactivity-timer, and sidelink HARQ RTT timer to be used by the UE with sidelink DRX configured. The sidelink HARQ RTT timer may be configured with a value that can be used in the corresponding HARQ process when HARQ feedback is configured for at least one or more sidelink logical channels (e.g., when HARQ feedback enabled is configured). The sidelink HARQ RTT timer may be configured with a value that can be used in the corresponding HARQ process when HARQ feedback is not configured for at least one or more sidelink logical channels (e.g., when HARQ feedback disabled is configured). FIG. 10B may also be applied to a receiving UE of sidelink groupcast or sidelink broadcast. For example, when configured to receive sidelink groupcast or sidelink broadcast-based data and signaling, the UE may acquire, from the NW 1050 in step 1011, the sidelink DRX configuration information configured to be used for sidelink groupcast or sidelink broadcast-based data and signaling.

With reference to FIG. 10C, the UE 1000 may acquire preconfigured sidelink DRX configuration information in step 1021. Sidelink DRX configuration information may be included in the preconfigured sidelink DRX configuration information. The sidelink DRX configuration information may include at least one or a combination of a sidelink DRX cycle, sidelink on-duration, sidelink inactivity-timer, and sidelink HARQ RTT timer to be used by the UE with sidelink DRX configured. The sidelink HARQ RTT timer may be configured with a value that can be used in the corresponding HARQ process when HARQ feedback is configured for at least one or more sidelink logical channels (e.g., when HARQ feedback enabled is configured). The sidelink HARQ RTT timer may be configured with a value that can be used in the corresponding HARQ process when HARQ feedback is not configured for at least one or more sidelink logical channels (e.g., when HARQ feedback disabled is configured). FIG. 10C may also be applied to a receiving UE of sidelink groupcast or sidelink broadcast. For example, when configured to receive sidelink groupcast or sidelink broadcast-based data and signaling, the UE may acquire, in step 1021, the sidelink DRX configuration information configured to be used for sidelink groupcast or sidelink broadcast-based data and signaling.

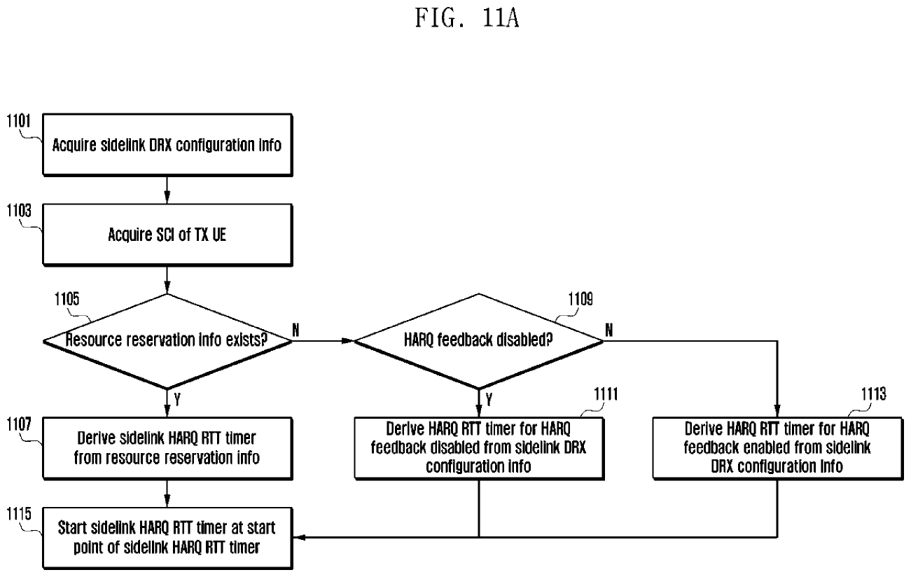

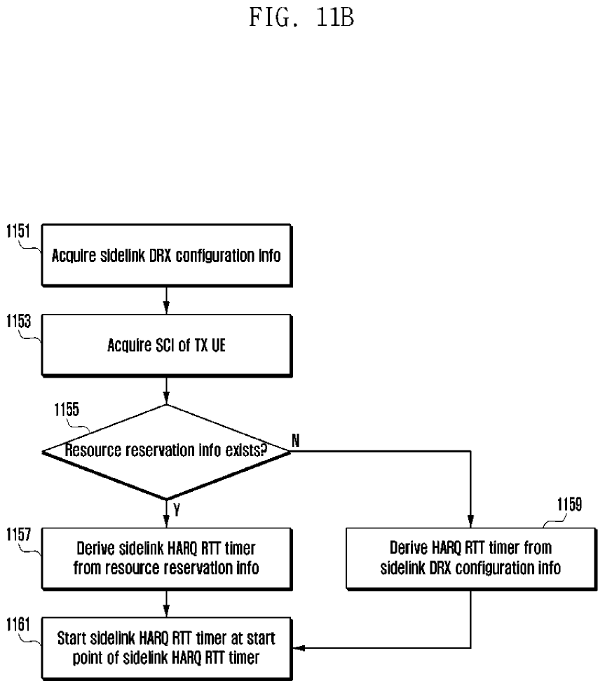

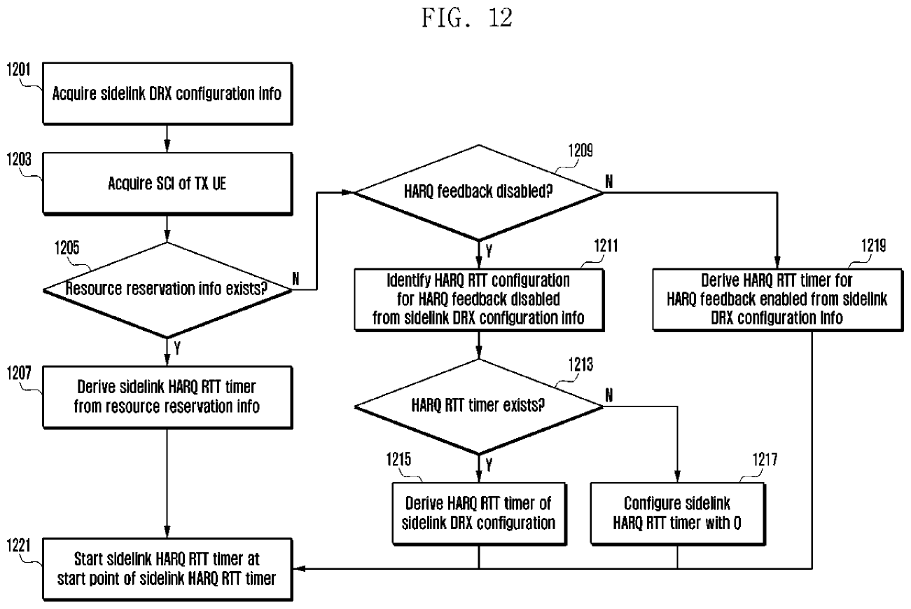

Next, the operation of the receiving UE that has acquired the sidelink DRX configuration information from the transmitting UE or the NW to process the sidelink HARQ RTT timer will be described with reference to FIGS. 11A, 11B, and 12. The embodiments of FIGS. 11A and 11B include a case where the sidelink HARQ RTT timer usable when processing a HARQ process in which HARQ feedback disabled is configured for a sidelink logical channel is configured with 0 or a value greater than 0.

FIGS. 11A and 11B are diagrams illustrating UE operations of operating an HARQ RTT timer of sidelink DRX according to various embodiments of the disclosure. If the receiving UE determines that sidelink control information (SCI) of the transmitting UE does not contain resource reservation information, and derives the sidelink HARQ RTT timer from the sidelink DRX configuration information, the case where a sidelink HARQ RTT timer value is configured separately with a value used in the HARQ process corresponding to HARQ feedback enabled and a value used in the HARQ process corresponding to HARQ feedback disabled will be described with reference to FIG. 11A. On the other hand, the case where the value used in the HARQ process corresponding to HARQ feedback enabled and the value used in the HARQ process corresponding to HARQ feedback disabled are configured equally will be described with reference to FIG. 11B.

With reference to FIG. 11A, first, in step 1101, the receiving UE may acquire sidelink DRX configuration information. For example, when supporting and operating sidelink DRX, the receiving UE may acquire the sidelink DRX configuration information from the transmitting UE, the NW, or pre-configuration in step 1101. The sidelink DRX configuration information may include a sidelink HARQ RTT timer, and the sidelink HARQ RTT timer may include at least one of a sidelink HARQ RTT timer when indicated as HARQ feedback enabled, and a sidelink HARQ RTT timer when indicated as HARQ feedback disabled. The receiving UE may acquire sidelink control information (SCI) from the transmitting UE in step 1103. The receiving UE may determine in step 1105 whether the acquired SCI includes resource reservation information. If it is determined that the acquired SCI includes resource reservation information, in step 1107, the receiving UE may determine time information of the next sidelink grant indicated by the resource reservation information of the SCI, and derive the sidelink HARQ RTT timer by considering the next sidelink grant time information. In step 1115, the receiving UE may initiate the sidelink HARQ RTT timer derived in step 1107 at the start point of the sidelink HARQ RTT timer.

If it is determined in step 1105 that the SCI acquired by the receiving UE does not include resource reservation information, the receiving UE may determine in step 1109 whether HARQ feedback disabled is configured for the HARQ process indicated by the SCI. If it is determined that HARQ feedback disabled is configured for the HARQ process indicated by the SCI, in step 1111, the receiving UE may derive, from the sidelink DRX configuration information acquired in step 1101, sidelink HARQ RTT timer information to be used in the HARQ process corresponding to HARQ feedback disabled. In step 1115, the receiving UE may initiate the sidelink HARQ RTT timer derived in step 1111 for the HARQ process indicated by the SCI at the start point of the sidelink HARQ RTT timer.

If it is determined in step 1109 that HARQ feedback disabled is not configured for the HARQ process indicated by the SCI, for example, if it is determined that HARQ feedback enabled is configured for the HARQ process indicated by the SCI, in step 1113, the receiving UE may derive, from the sidelink DRX configuration information acquired in step 1101, sidelink HARQ RTT timer information to be used in the HARQ process corresponding to HARQ feedback enabled. In step 1115, the receiving UE may initiate the sidelink HARQ RTT timer derived in step 1113 for the HARQ process indicated by the SCI at the start point of the sidelink HARQ RTT timer.

Meanwhile, with reference to FIG. 11B, when supporting and operating the sidelink DRX, the receiving UE may acquire the sidelink DRX configuration information from the transmitting UE, the NW, or pre-configuration in step 1151. The sidelink DRX configuration information may include a sidelink HARQ RTT timer. The sidelink HARQ RTT timer may include a sidelink HARQ RTT timer that can be used together when indicated as HARQ feedback enabled and when indicated as HARQ feedback disabled. The receiving UE may acquire sidelink control information (SCI) from the transmitting UE in step 1153. The receiving UE may determine in step 1155 whether the acquired SCI includes resource reservation information.

If it is determined that the acquired SCI includes resource reservation information, in step 1157, the receiving UE may determine time information of the next sidelink grant indicated by the resource reservation information of the SCI, and derive the sidelink HARQ RTT timer by considering the next sidelink grant time information. In step 1161, the receiving UE may initiate the sidelink HARQ RTT timer derived in step 1157 at the start point of the sidelink HARQ RTT timer.

If it is determined in step 1155 that the SCI acquired by the receiving UE does not include resource reservation information, in step 1159, the receiving UE may derive, from the sidelink DRX configuration information acquired in step 1151, the sidelink HARQ RTT timer information to be used in the HARQ process indicated by the SCI. For example, the sidelink HARQ RTT timer included in the sidelink DRX configuration information may be equally applied to the HARQ process corresponding to HARQ feedback enabled or the HARQ process corresponding to HARQ feedback disabled. In step 1161, the receiving UE may initiate the sidelink HARQ RTT timer derived in step 1159 for the HARQ process indicated by the SCI at the start point of the sidelink HARQ RTT timer.

Meanwhile, the embodiment of FIG. 12 include a case where the sidelink HARQ RTT timer usable when processing a HARQ process in which HARQ feedback disabled is configured for a sidelink logical channel is configured with a value greater than 0, and if the sidelink HARQ RTT timer is not configured, 0 is used.

FIG. 12 is a diagram illustrating UE operations of operating an HARQ RTT timer of sidelink DRX according to an embodiment of the disclosure.

With reference to FIG. 12, when supporting and operating sidelink DRX, the receiving UE may acquire the sidelink DRX configuration information from the transmitting UE, the NW, or pre-configuration in step 1201. The sidelink DRX configuration information may include a sidelink HARQ RTT timer. The sidelink HARQ RTT timer may include at least one of a sidelink HARQ RTT timer when indicated as HARQ feedback enabled, and a sidelink HARQ RTT timer when indicated as HARQ feedback disabled. The receiving UE may acquire sidelink control information (SCI) from the transmitting UE in step 1203. The receiving UE may determine in step 1205 whether the acquired SCI includes resource reservation information. If it is determined that the acquired SCI includes resource reservation information, in step 1207, the receiving UE may determine time information of the next sidelink grant indicated by the resource reservation information of the SCI, and derive the sidelink HARQ RTT timer by considering the next sidelink grant time information. In step 1221, the receiving UE may initiate the sidelink HARQ RTT timer derived in step 1207 at the start point of the sidelink HARQ RTT timer. If it is determined that the SCI acquired by the receiving UE does not include the resource reservation information, the receiving UE may determine in step 1209 whether HARQ feedback disabled is configured for the corresponding HARQ process in the SCI. If it is determined that HARQ feedback disabled is configured for the corresponding HARQ process in the SCI, the receiving UE may determine in step 1211, from the sidelink DRX configuration information acquired in step 1201, whether sidelink HARQ RTT timer information to be applied in the case of HARQ feedback disabled is configured. If it is determined in step 1213 that the sidelink HARQ RTT timer information to be applied in the case of HARQ feedback disabled is configured in the sidelink DRX configuration information, the receiving UE may derive sidelink HARQ RTT timer information from the sidelink DRX configuration information in step 1215. In step 1221, the receiving UE may initiate the sidelink HARQ RTT timer derived in step 1215 for the HARQ process indicated by the SCI at the start point of the sidelink HARQ RTT timer.

If it is determined in step 1213 that the sidelink HARQ RTT timer information to be applied in the case of HARQ feedback disabled is not configured in the sidelink DRX configuration information, the receiving UE may determine in step 1217 that the sidelink HARQ RTT timer should be configured with 0. In step 1221, the receiving UE may initiate the sidelink HARQ RTT timer derived in step 1217 for the HARQ process indicated by the SCI at the start point of the sidelink HARQ RTT timer. For example, the receiving UE configures the sidelink HARQ RTT timer to 0.

On the other hand, if it is determined in step 1209 that HARQ feedback disabled is not configured for the HARQ process indicated by the SCI, for example, if it is determined that HARQ feedback enabled is configured for the HARQ process indicated by the SCI, in step 1219, the receiving UE may derive, from the sidelink DRX configuration information acquired in step 1201, the sidelink HARQ RTT timer information to be used in the HARQ process corresponding to HARQ feedback enabled. Then, in step 1221, the receiving UE may initiate the sidelink HARQ RTT timer derived in step 1219 at the start point of the sidelink HARQ RTT timer.

A specific embodiment in which the receiving UE derives the sidelink HARQ RTT timer and initiates the sidelink HARQ RTT timer according to the embodiments of FIGS. 11A, 11B, and 12 is as follows.

In an embodiment, through a physical sidelink feedback channel (PSFCH), the receiving UE may transmit ACK or NAK for data acquired in the HARQ process configured with HARQ feedback enabled. The receiving UE that has transmitted ACK or NAK for data may perform an operation to initiate the sidelink HARQ RTT timer. In this case, the sidelink HARQ RTT timer may be initiated at a designated point in time (e.g., X-th slot or Y-th symbol) after transmitting ACK or NAK for data. The sidelink HARQ RTT timer corresponds to the minimum time for the receiving UE to wait for a sidelink grant for retransmission data, and the receiving UE may configure it with a value acquired from the sidelink DRX configuration information. When the sidelink HARQ RTT timer expires and there is a need to receive retransmission data, the receiving UE may perform an operation to initiate the sidelink retransmission timer. In this case, the sidelink retransmission timer may be initiated at a designated point in time (e.g., the A-th slot or the B-th symbol) after the sidelink HARQ RTT timer expires. In an embodiment, the receiving UE may acquire data from the HARQ process that is configured with HARQ feedback disabled. The receiving UE may wait for data retransmission in the corresponding HARQ process without needing to transmit ACK or NAK for the acquired data. The receiving UE may perform an operation to initiate the sidelink HARQ RTT timer. In the case of HARQ feedback disabled, it is not possible to perform the operation of initiating the sidelink HARQ RTT timer by considering the timing of ACK or NAK transmission for data, so time information for a start point at which the receiving UE can initiate the sidelink HARQ RTT timer may be configured separately. The start point of initiating the sidelink HARQ RTT timer may be a designated point in time (e.g., L-th slot or M-th symbol) after PSSCH for data is received. The sidelink HARQ RTT timer corresponds to the minimum time for the receiving UE to wait for a sidelink grant for retransmission data, and the receiving UE may configure it with a value acquired from the sidelink DRX configuration information. When the sidelink HARQ RTT timer expires and there is a need to receive retransmission data, the receiving UE may perform an operation to initiate the sidelink retransmission timer. In this case, the sidelink retransmission timer may be initiated at a designated point in time (e.g., the A-th slot or the B-th symbol) after the sidelink HARQ RTT timer expires.

Meanwhile, the embodiments of FIGS. 11A, 11B, and 12 have been described in the case where, for the HARQ process configured with HARQ feedback disabled, the receiving UE uses the sidelink HARQ RTT timer acquired through a unicast-based PC5 RRC message between the transmitting UE and the receiving UE, or the receiving UE uses the sidelink HARQ RTT timer acquired to operate sidelink DRX in sidelink groupcast or sidelink broadcast. In another embodiment, instead of being configured with the sidelink HARQ RTT timer to be used for the HARQ process with HARQ feedback disabled in a PC5 RRC unicast message with the transmitting UE or control signaling of the NW or pre-configuration, the receiving UE may acquire information indicating the sidelink HARQ RTT timer from sidelink control information (SCI) transmitted by the transmitting UE. For example, if it is determined that the HARQ process configured with HARQ feedback disabled indicated by the SCI of the transmitting UE does not include transmission resource reservation information and includes sidelink HARQ RTT timer information, the receiving UE may apply the sidelink HARQ RTT timer indicated for the HARQ process.

The methods according to embodiments set forth in claims or specification of the disclosure may be implemented in the form of hardware, software, or a combination thereof.

When implemented in software, a computer readable storage medium storing one or more programs (software modules) may be provided. One or more programs stored in the computer readable storage medium are configured for execution by one or more processors in an electronic device. One or more programs include instructions for causing an electronic device to execute methods according to embodiments described in claims or specifications of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), other types of optical storage devices, or magnetic cassettes. Alternatively, such programs may be stored in a memory configured with a combination of some or all thereof. Further, each configuration memory may be included in the plural.

Further, the program may be stored in an attachable storage device that may access through a communication network such as Internet, Intranet, a local area network (LAN), a wide area network (WAN), or a storage area network (SAN), or a communication network configured with a combination thereof. Such a storage device may access to a device implementing an embodiment of the disclosure through an external port. Further, a separate storage device on the communication network may access to the device implementing the embodiment of the disclosure.

In the specific embodiments of the disclosure described above, components included in the disclosure are expressed in the singular or the plural according to the presented specific embodiments. However, the singular or plural expression is appropriately selected for the presented situation for convenience of description, and the disclosure is not limited to the singular or plural components, and even if the component is expressed in the plural, the component may be configured with the singular, or even if the component is expressed in the singular, the component may be configured with the plural.

Although specific embodiments have been described in the detailed description of the disclosure, various modifications are possible without departing from the scope of the disclosure. Therefore, the scope of the disclosure should not be limited to the described embodiments and should be defined by claims set forth below as well as equivalents to claims.

1. A method of a terminal performing sidelink wireless communication in a wireless communication system, the method comprising:
identifying whether resource reservation information is included in sidelink control information (SCI);
in case that the resource reservation information is included in the SCI, deriving a sidelink hybrid automatic repeat request (HARQ) round trip time (RTT) timer from the resource reservation information;
in case that the resource reservation information is not included in the SCI, determining the sidelink HARQ RTT timer from DRX configuration information; and
initiating the sidelink HARQ RTT timer.

2. The method of claim 1, wherein the determining further comprising:
in case that the resource reservation information is not included in the SCI, identifying whether HARQ feedback is enabled or disabled for an HARQ process;
in case that the HARQ feedback is enabled for the HARQ process, identifying a first sidelink HARQ RTT timer for HARQ feedback enabled configured in the DRX configuration information;
in case that the HARQ feedback is disabled for the HARQ process, identifying a second sidelink HARQ RTT timer for HARQ feedback disabled configured in the DRX configuration information; and
determining the identified first sidelink HARQ RTT timer or the identified second sidelink HARQ RTT timer as the sidelink HARQ RTT timer.

3. The method of claim 1, wherein the deriving includes:
in case that the resource reservation information is included in the SCI, deriving the sidelink HARQ RTT timer based on timing of a next retransmission resource indicated in the SCI.

4. The method of claim 1, further comprising:
through higher layer signaling, receiving DRX configuration information including a value for a first sidelink HARQ RTT timer for HARQ feedback enabled and a value for a second sidelink HARQ RTT timer for HARQ feedback disabled.

5. The method of claim 1, wherein the initiating further comprising:
transmitting ACK or NACK for data in an HARQ process; and
initiating the sidelink HARQ RTT timer in a slot of a preconfigured point in time after the transmission.

6. The method of claim 1, further comprising:
monitoring the SCI at an active time of a sidelink DRX cycle.

7. A terminal performing sidelink wireless communication in a wireless communication system, the terminal comprising:
a transceiver; and
a controller controlling to:
identify whether resource reservation information is included in sidelink control information (SCI),
in case that the resource reservation information is included in the SCI, derive a sidelink hybrid automatic repeat request (HARQ) round trip time (RTT) timer from the resource reservation information,
in case that the resource reservation information is not included in the SCI, determine the sidelink HARQ RTT timer from DRX configuration information, and
initiate the sidelink HARQ RTT timer.

8. The terminal of claim 7, wherein the controller controls to:
in case that the resource reservation information is not included in the SCI, identify whether HARQ feedback is enabled or disabled for an HARQ process,
in case that the HARQ feedback is enabled for the HARQ process, identify a first sidelink HARQ RTT timer for HARQ feedback enabled configured in the DRX configuration information,
in case that the HARQ feedback is disabled for the HARQ process, identify a second sidelink HARQ RTT timer for HARQ feedback disabled configured in the DRX configuration information, and
determine the identified first sidelink HARQ RTT timer or the identified second sidelink HARQ RTT timer as the sidelink HARQ RTT timer.

9. The terminal of claim 7, wherein the controller controls to:
in case that the resource reservation information is included in the SCI, derive the sidelink HARQ RTT timer based on timing of a next retransmission resource indicated in the SCI.

10. The terminal of claim 7, wherein the controller controls to:
through higher layer signaling, receive DRX configuration information including a value for a first sidelink HARQ RTT timer for HARQ feedback enabled and a value for a second sidelink HARQ RTT timer for HARQ feedback disabled through the transceiver.

11. The terminal of claim 7, wherein the controller controls to:
transmit ACK or NACK for data in an HARQ process through the transceiver, and initiate the sidelink HARQ RTT timer in a slot of a preconfigured point in time after the transmission.

12. The terminal of claim 7, wherein the controller controls to:
monitor the SCI at an active time of a sidelink DRX cycle.
